(19) United States
(12) Patent Application Publication
(10) Pub. No.: US 2024/0236260 A9
(43) Pub. Date: Jul. 11, 2024

(54) PORTABLE STUDIO SYSTEM AND DEVICE

(71) Applicant: So Okazaki, Kawaguchi (JP)

(72) Inventor: So Okazaki, Kawaguchi (JP)

(21) Appl. No.: 18/381,493

(22) Filed: Oct. 18, 2023

Related U.S. Application Data
(60) Provisional application No. 63/417,601, filed on Oct. 19, 2022.

(30) Foreign Application Priority Data
Apr. 19, 2023 (JP) 35002348

(51) Int. Cl. H04N 5/28; G03B 17/56

(52) U.S. Cl. CPC H04N 5/28; G03B 17/561

(57) ABSTRACT

A portable studio system device includes an upper portion hingedly connected to a lower portion. The upper portion includes a hinged main support plate that can pivot into a deployed configuration and a stowed configuration. The lower portion may include a control housing for receiving a control interface for powering and interfacing electronic devices. Support members facilitate selective formation of horizontal support surfaces. In some embodiments, slots in the lower portion and holes in the plate receive the support members to secure the plate in the deployed configuration, forming an elevated support surface for supporting electronic devices in a standing position. Alternatively, brackets receive the support members across the lower portion, forming a lower support area for supporting electronic devices in a sitting position.

### RELATED APPLICATION

This application claims benefit to U.S. Provisional Application No. 63/417,601 filed Oct. 19, 2022; U.S. Design application No. 29/857,107 filed Oct. 19, 2022; U.S. Design application No. 29/857,111 filed Oct. 19, 2022; U.S. Design application No. 29/857,114 filed Oct. 19, 2022; and International Design Application No. 35002348, filed Apr. 19, 2023, all of which are incorporated by reference herein in their entirety.

### BACKGROUND

The present disclosure relates generally to systems and devices for storage, transport, and set up of studio equipment.

With the advent of social media as a means for delivering content, increased consumers, particularly entrepreneurs, influencers, and the like, are interested in optimizing the content streamed or recorded for their audience. Further, with the advent of remote work and the requirement of virtual meetings as a means for conducting business, more consumers are interested in optimizing their virtual presence, environment, and capabilities over these meetings to deliver better, more effective content in their presentations, pitches, and marketing and advertising material. As such, an improved system for studio setup for content creation and delivery is desirable.

### SUMMARY

According to various embodiments, disclosed is portable studio system and a portable studio system device providing a portable desktop stand including a content generating video studio. In certain embodiments, the device enables remote deployment of the video studio for enabling content creation while traveling or in remote locations.

An aspect of an example embodiment in the present disclosure is to provide a travel ready case providing accessibility to a content creating video studio. Accordingly, the present disclosure provides a compact case including a portable desktop stand having video studio quality lights, cameras, microphones, control interfaces, and a control hub for powering various electronic devices.

Another aspect of an example embodiment in the present disclosure is to provide a travel ready case including a content creating video studio that is quickly deployable enabling quick set up of the studio. Accordingly, the present disclosure provides a portable desktop stand system including a configuration enabling quick deployment and set up of the internal video studio components.

Yet another aspect of an example embodiment in the present invention is to provide a deployable computer stand capable of sustaining various electronic devices thereon. Accordingly, the case includes a built-in main support plate that can quickly pivot in a deployed configuration to form a horizontal computer table stand capable of sustaining one or more electronic devices.

In yet another aspect of an example embodiment in the present invention is to provide a deployable computer stand that can accommodate a computer in a desktop configuration as well as a standing configuration. Accordingly, the case includes support members that support the main support plate in an elevated position accommodating use of the system in a standing position and that also attach to the case in a manner that forms a lower horizontal support surface for accommodating use of the system in a desktop position.

Still another aspect of an example embodiment in the present invention is to provide a case including an internal control module for powering the electronic devices and enabling the coupling and operation of the electronic devices at once to achieve video studio-like capabilities. Accordingly, the present disclosure provides a housing disposed within the case including ventilation, a power source, a power jack for connecting to a power cable and establishing an electrical connection to the system and providing power thereto, and a control module receptacle for receiving a multiport docking station hub adaptor for receiving various types of cables to make connections with various types of electronic devices requiring varying electrical cables for operation.

It shall be understood that the disclosed subject matter may address one or more of aspects, as well as providing other benefits and advantages in a number of technical areas. Therefore, the claims should not necessarily be construed as limited to addressing any of the particular aspects discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE FIGURES

The detailed description of some embodiments of the invention will be made below with reference to the accompanying figures, wherein the figures disclose one or more embodiments of the present invention.

FIG. 1 is a perspective view of a portable studio system device in a closed position according to certain embodiments.

FIG. 2 is a perspective view of the portable studio system device in an open position, illustrating components of the device in a stowed configuration according to certain embodiments.

FIG. 3 is a perspective view of the portable studio system device in the open position, illustrating a pair of light sources and camera deployed for use according to certain embodiments.

FIG. 4 is a right-side perspective view of the portable studio system device in the open position, illustrating support members of the device forming a lower planar horizontal support area configured to receive and maintain an object such as a smart electronic device thereon for a sitting desktop setup, according to certain embodiments.

FIG. 5 is a left-side perspective view of the portable studio system device, illustrating the support members forming a lower planar horizontal support area configured to receive and maintain an object such as a smart electronic device thereon for a sitting desktop setup.

FIG. 6 is a perspective view of the portable studio system device in the open position, illustrating a laptop supported on the support members in the sitting desktop setup.

FIG. 7 is a perspective view of the portable studio system device in the open position, illustrating a main support plate of the device partially deployed for a standing setup, according to certain embodiments.

FIG. 8 is a perspective view of the portable studio system device in the open position, illustrating the main support plate in a fully deployed configuration with the support members inserted into a pair of slots in a lower portion just prior to engagement with the main support plate, according to certain embodiments.

FIG. 9 is a perspective view of the portable studio system device in the open position, illustrating the portable desktop stand system in the standing configuration in which the support members are engaged to the main support plate to support the main support plate in its deployed configuration according to certain embodiments.

FIG. 10 is a perspective view of the portable studio system device in the open position, illustrating a pair of light sources and the camera deployed for use when the portable desktop stand is set up in the standing position according to certain embodiments.

FIG. 11 is a perspective view of the portable studio system device in the open position, illustrating a touch pad interface holder pivoted with respect to a cut-out within the main support plate for an adjustable orientation with respect to the main support plate according to certain embodiments.

FIG. 12 is a top perspective view of the portable studio system device in the open position, illustrating an auxiliary support plate extended from the main support plate into an extended configuration forming an additional horizontal support surface configured to receive and maintain another smart electronic device according to certain embodiments.

FIG. 13 is a top perspective view of the portable studio system device in the open position, illustrating the auxiliary support plate in its extended configuration and supporting a computer tablet thereon according to certain embodiments.

FIG. 14 is a bottom perspective view of the portable studio system device in the open position, illustrating the auxiliary support plate in its extended configuration according to certain embodiments.

FIG. 15 is a perspective view of the portable studio system device in the open position, illustrating the stand in the standing position without the studio components according to certain embodiments.

### DETAILED DESCRIPTION OF CERTAIN EMBODIMENTS

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

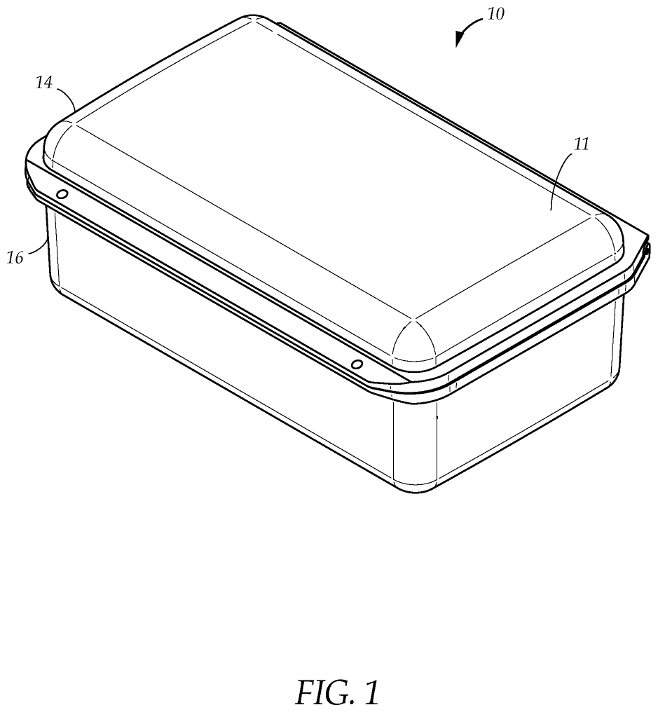

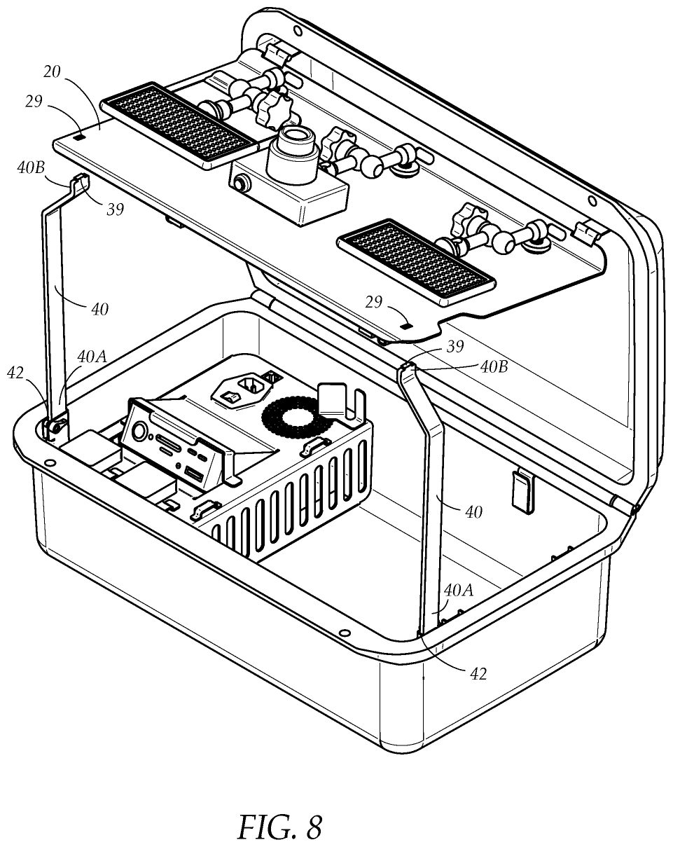

According to various embodiments as depicted in FIGS. 1-15 disclosed is a portable studio system and a portable studio system device 10 configured to facilitates studio equipment setup for content creation and delivery, and to provide storage and transport for studio equipment. In some embodiments, the disclosed device and system provides ah support platform or desktop stand for support of studio equipment, which is versatile in that it can adjust between a lower (i.e. sitting) and an upper (standing) supportive platform, and may further be optionally expandable. According to various embodiments, the disclosed device and system may be used for content creation and delivery, including for photographing, videoing, and presentation, or as a workstation, amongst other uses.

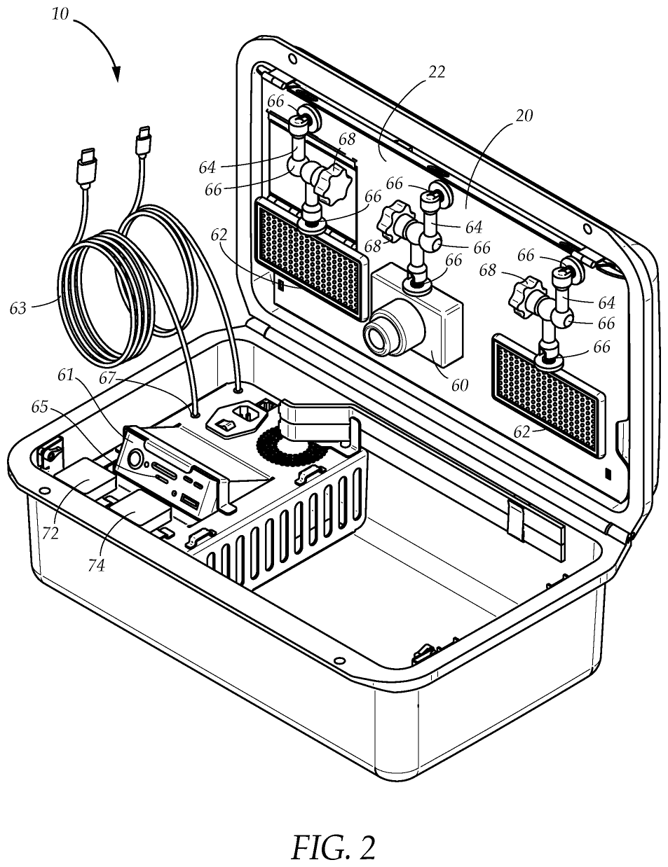

In embodiments, device 10 comprises a case 11 having an upper portion 14, and a lower portion 16, which may be hingedly connected enabling upper portion 14 and lower portion 16 to selectively pivot with respect to one another between a closed position as shown in FIG. 1, and an open position as shown in FIGS. 2-15. In the open position, case 11 provides access to an interior compartment 12 which is sealed in the closed position. In certain embodiments, case 11 may house studio system support components and/or studio system equipment as will be described.

In certain embodiments, a main support plate 20 may be hingedly coupled to an interior side of upper portion 14, and is configured to pivot outwardly into a deployed configuration and inwardly into a stowed configuration with respect to upper portion 14. In one embodiment, upper portion 14 includes an interior side ceiling 18, an upper perimeter edge 18P, and a wall 18W extending between ceiling 18 and upper perimeter edge 18P, wherein main support plate 20 may be hingedly connected to wall 18W. In certain embodiments, wall 18W may be substantially orthogonal to ceiling 18. In some embodiments, main support plate 20 may be substantially orthogonal relative to ceiling 18 in its deployed configuration, and substantially parallel to ceiling 18 in its stowed configuration. Wall 18W in conjunction with ceiling 18 may further define an upper receptacle 30 configured to receive main support plate 20 therein when main support plate 20 is in stowed configuration.

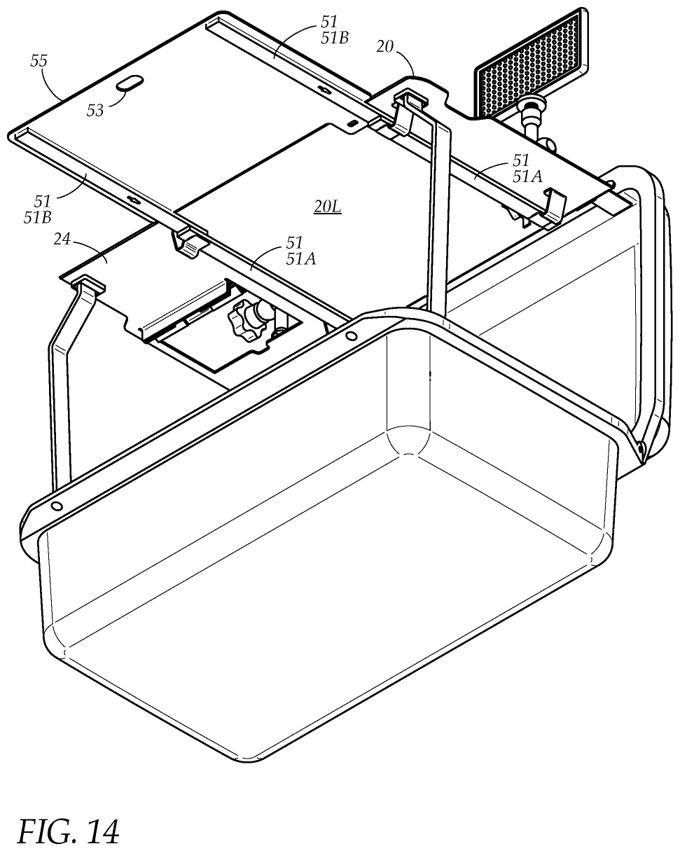

Main support plate 20 may generally be defined by an upper surface 20U, a lower surface 20L (see FIG. 14) opposite upper surface 20U, a rear side 22 including a rear edge 22E, a front side 24 including a front edge 24E, a first side 26 including a first side edge 26E, and a second side 28 including a second side edge 28E, wherein rear side 22 is opposite front side 24 and first side 26 is opposite second side 28. In certain embodiments, main support plate 20 may include a first notch 21 disposed along first side edge 26E adjacent to, or toward, front side 24, and/or a second notch 23 disposed along second side edge 28E adjacent to, or toward, front side 24. In some embodiments, main support plate 20 is substantially co-extensive with upper receptacle 30, for example, such that the cross-sectional area of the main support plate 20 is substantially equal to the cross-sectional area of the upper receptacle 30. First and/or second notches 21, 23 provide a space between the first side edge 26E and second sides edges 28E of main support plate 20 and the wall 18W of the upper portion 14 in which a user may place his or her fingers to grasp the main support plate 20 and transition, or pivot, the main support plate 20 between the stowed configuration and the deployed configuration.

In embodiments, lower portion 16 may include a base 32 having a lower perimeter edge 32P. In certain embodiments, an upstanding wall 34 may extend substantially orthogonally upwards from lower perimeter edge 32P. Upstanding wall 34 includes a rear wall 34R, a front wall 34F opposite the rear wall 34R, a first side wall 34A, and a second side wall 34B opposite the first side wall 34A. Rear wall 34R, front wall 34F, first side wall 34A, and second side wall 34B all define a lower receptacle 36 in conjunction with base 32. In some embodiments, lower receptacle 36 may include a control module receiving center 38 configured to removably receive a control interface for powering and interfacing with various electronic devices. In certain embodiments, control module receiving center 38 may comprise a housing 38H positioned within the lower receptacle 36. In some embodiments, housing 38H may include components such as an exhaust and/or intake ventilation 38V; a network jack 38N, such as an ethernet port, for connecting to wired network hardware in an Ethernet LAN, metropolitan area network (MAN), or wide area network (WAN) to connect to the Internet; a power supply 38P; a power jack 38J to connect a power cable and establish an electrical connection; and/or a control module receptacle 38R for receiving a multiport docking station hub adaptor for receiving various types of cables in order to make connections with various types of electronic devices requiring varying electrical cables for operation.

In certain embodiments, device 10 may further house at least two support members 40, or preferably a pair of support members 40, for supporting main support plate 20 in the deployed configuration. In certain embodiments, a support member stowing bracket 44 for stowing the pair of support members 40 may be provided within lower receptacle 36. In one embodiment, support member stowing bracket 44 may include a first slot member 44A disposed on the rear wall 34R and a second slot member 44B disposed on the housing 38H of the control module receiving center 38.

In some further embodiments, at least two support member upright holders 42, preferably comprising a pair of slots 42, may be disposed on opposite sides of the upstanding wall 34 and are configured for receiving support members 40 at or proximate a first end 40A of each of support members 40. Main support plate 20 may further include a pair of holes 29 disposed on opposite sides of support surface 20 adjacent to, or toward, front side 24, the pair of holes 29 being configured for receiving support members 40 at or proximate a second end 40B of support members 40, opposite the first end. In certain embodiments the pair of support members 40 may each include a projection 39 at second end 40B of each support member 40, the projections being configured to engage the pair of holes 29 of the main support plate 20 to secure the main support plate 20 in the deployed configuration. As such, support members 40 may be supported within slots 42 in an upright position in which the support members 40 are substantially orthogonal with respect to base 32 and configured to receive and suspend main support plate 20 in the deployed configuration. When the pair of support members 40 are inserted into the pair of slots 42 and the projections 39 are engaging the pair of holes 29 of the main support plate 20, the main support plate 20 is secured in its deployed configuration, thereby forming an elevated planar horizontal support surface configured to receive and maintain objects such as one or more electronic device thereon in a standing position.

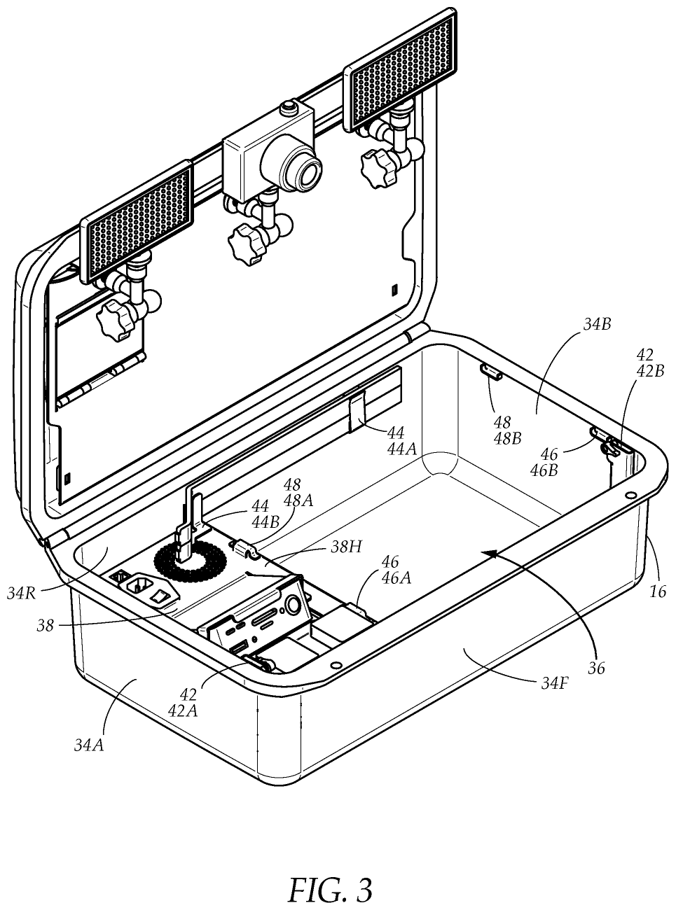

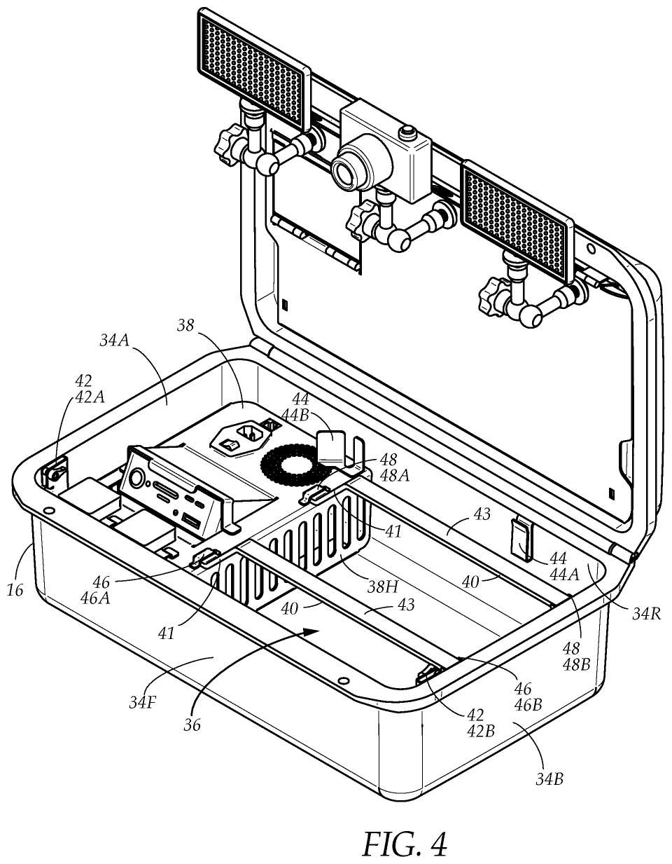

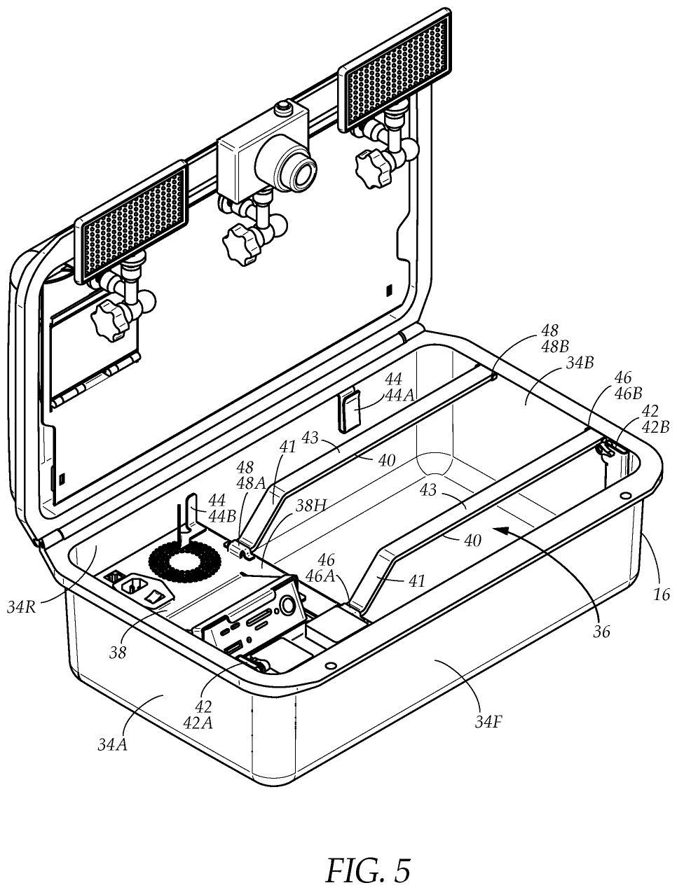

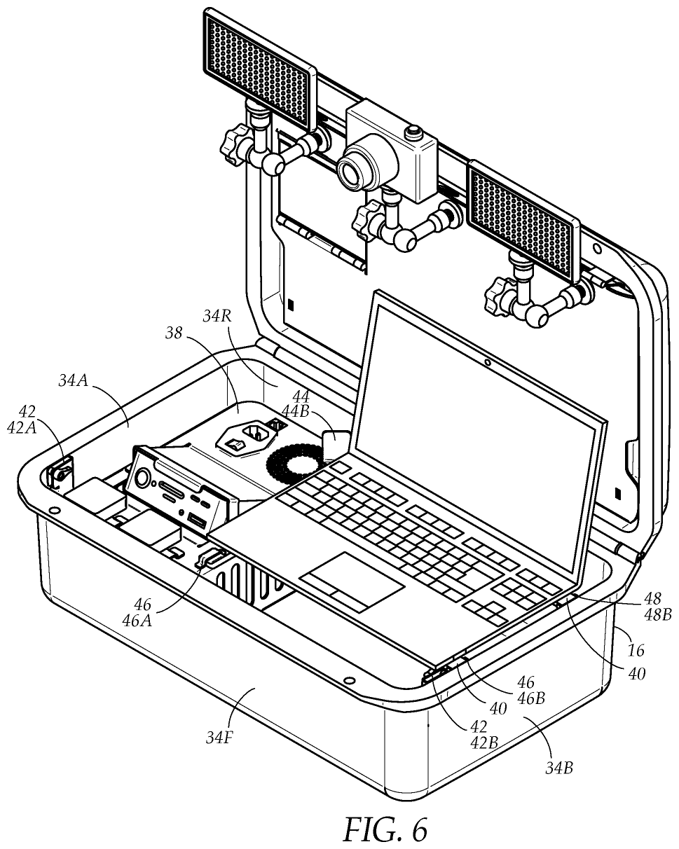

In certain embodiments, lower receptacle 36 may include a first set of brackets 46 for receiving and suspending one of the pair of support members 40 laterally across a width of the lower portion 16, and a second set of brackets 48 for receiving and suspending the other of the pair of support members 40 laterally across a width of the lower portion 16. Referring now to FIG. 3, FIG. 4, FIG. 5, and FIG. 6, in embodiments, the pair of slots 42 include a first slot 42A disposed on first side wall 34A and a second slot 42B on the second side wall 34B. The first slot 42A and the second slot 42B are symmetrically aligned over a central lateral axis of the lower receptacle 16. In one embodiment, first slot 42A may be adjacent to front wall 34F, and second slot 42B may be adjacent to front wall 34F. The first set of brackets 46 include a first bracket member 46A disposed on the housing 38H of the control module receiving center 38 and a second bracket member 46B disposed on the second side wall 34B. The first bracket member 46A and the second bracket member 46B are symmetrically aligned over a central lateral axis of the lower portion 16. The second set of brackets 48 include a third bracket member 48A disposed on the housing 38H of the control module receiving center 38 and a fourth bracket member 48B disposed on the second side wall 34B. The third bracket member 48A and the fourth bracket member 48B are symmetrically aligned over a central lateral axis of the lower portion 16. The first set of brackets 46 and the second set of brackets 48 are symmetrical over a central longitudinal axis of the lower portion 16. The support members 40 are thus removable from the lower receptacle 36, such that they may be removed from the support member stowing bracket 44 and selectively inserted into the pair of slots 42 or mounted onto the first and second set of brackets 46, 48.

Referring back to FIG. 4, FIG. 5, and FIG. 6, when the pair of support members 40 are mounted onto the first and second set of brackets 46, 48, the pair of support members 40 form a lower planar horizontal support area configured to receive and maintain objects such as one or more smart electronic devices, such as a laptop, thereon in a sitting desktop position. In some embodiments, the support members 40 include an angled portion 41 and a straight portion 43, in which the angled portion 41 extends at an angle with respect to the straight portion 43. The straight portion 43 forms the lower planar horizontal support area. Thus, essentially, the angled portion 41 raises the straight portion 43 with respect to the angled portion 41 when the pair of support members 40 are mounted horizontally onto the first set of brackets 46 and the second set of brackets 48, thereby elevating the lower planar horizontal support area with respect to the lower portion 16.

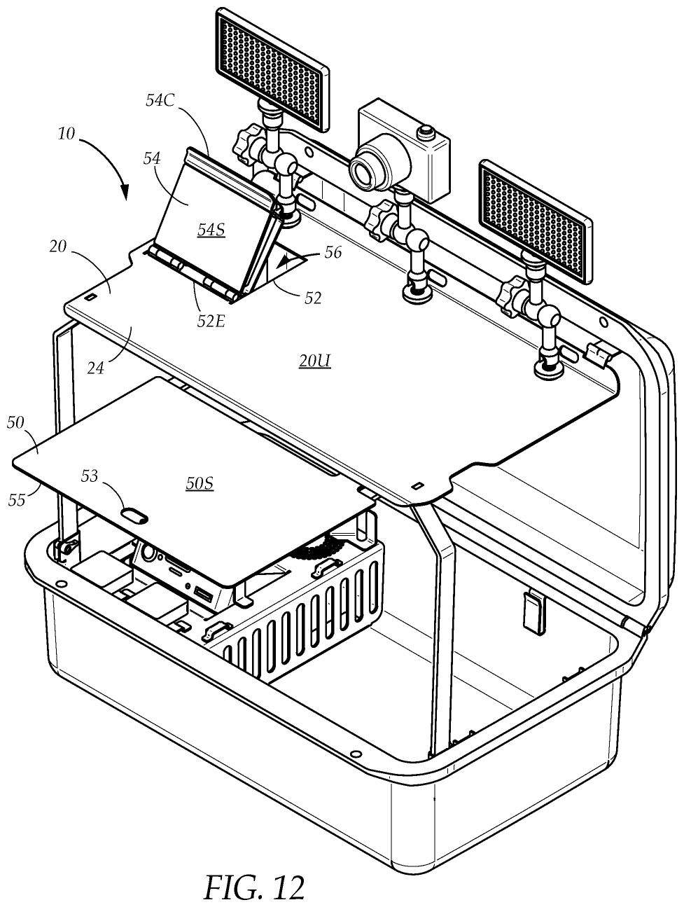

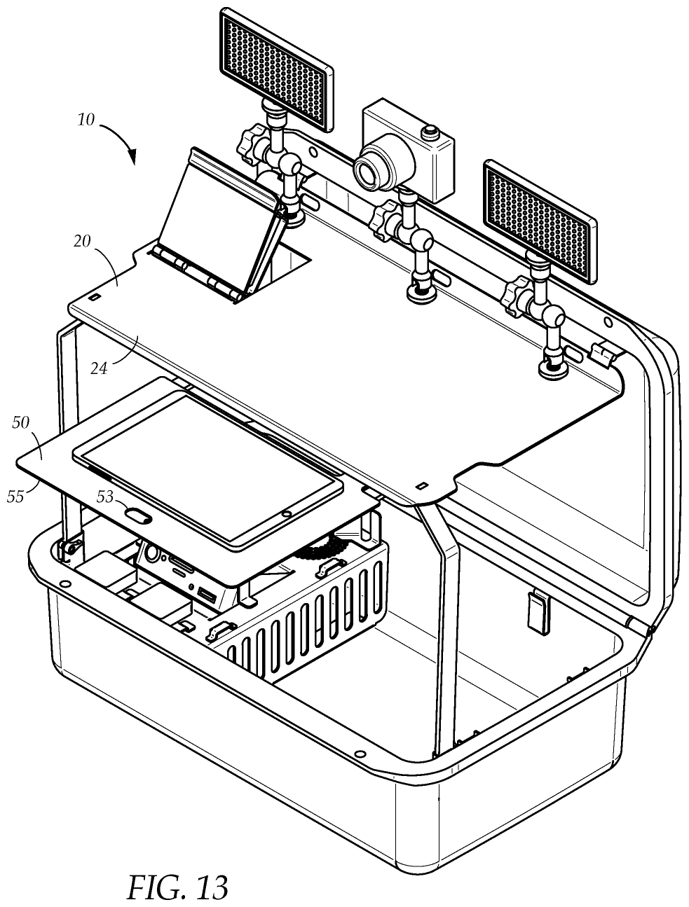

In certain embodiments as best depicted in FIG. 12, FIG. 13, and FIG. 14, device 10 may further comprise an auxiliary support plate 50 slidably disposed on lower surface 20L of the main support plate 20 via a rail system. In some embodiments, the rail system includes a pair of telescopic rails 51 attached to the lower surface 20L of the main support plate 20. Each pair of telescopic rails 51 includes a pair of members including a fixed member 51A coupled to the lower surface 20L and a sliding member 51B slidably disposed on the fixed member 51A. The auxiliary support plate 50 is attached to sliding members 51B of the pair of telescopic rails 51 enabling the auxiliary support plate to slide out from under the main support plate 20. In embodiments, auxiliary support plate 50 may include a hole 53 on a front end 55 thereof to enable a user to grasp the auxiliary support plate 50 to extend it out from under the main support plate 20. The auxiliary support plate 50 defines an auxiliary planar support surface 50S when extended from the main support plate 20. The auxiliary support plate 50 is extendable from the main support plate 20 such that at least a majority of the auxiliary planar support surface 50S extends past the front side 24 of the main support plate 20 to form an additional horizontal support surface configured to receive and maintain objects such as other smart electronic devices.

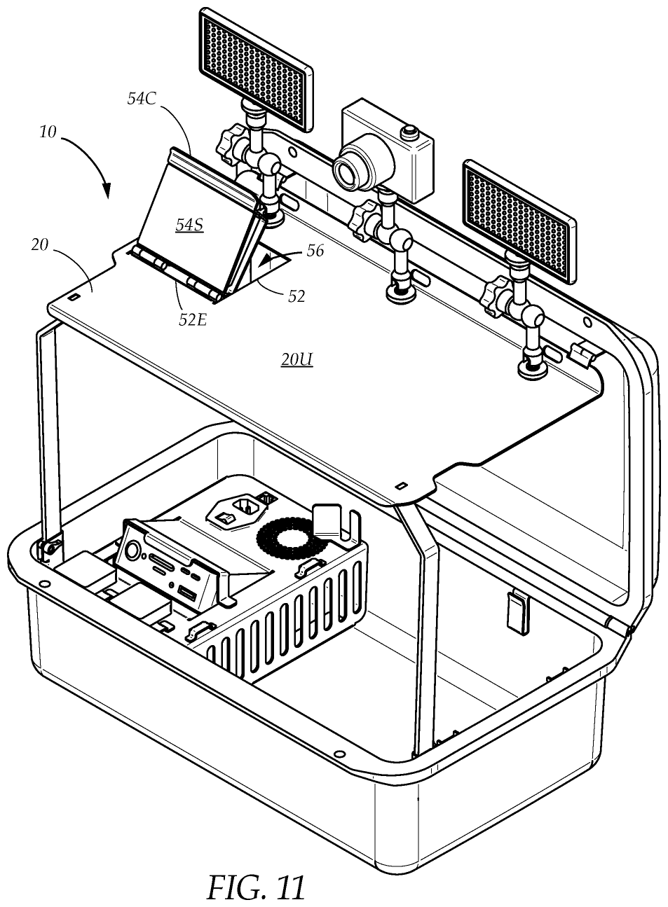

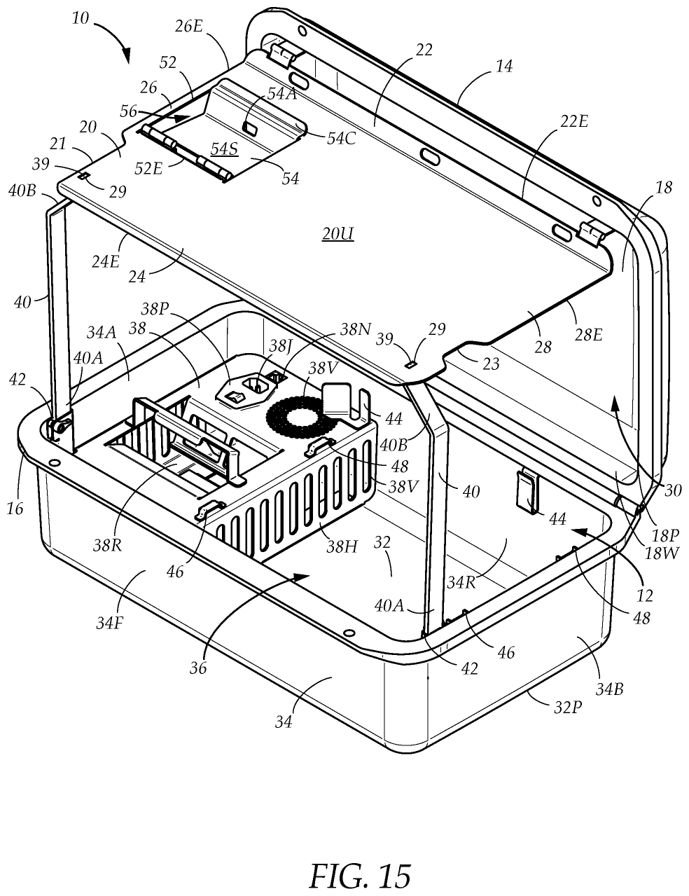

Referring back to FIG. 15, in conjunction with FIG. 11 and FIG. 12, in some embodiments, the main support plate 20 further includes a cut-out 52, which may extend entirely through the main support plate 20 from the upper surface 20U to the lower surface and a device holder 54 which may be configured for receiving and maintaining a touch pad interface device, such as a streaming deck like, for example, an Elgato® stream deck. The cut-out 52 includes a perimeter edge 52E defining an opening 56. The device holder 54 (also referred to as touch pad interface device holder 54) is positioned within the opening 56 and hingedly connected to the perimeter edge 52E of the cut-out 52. The touch pad interface device holder 54 is pivotable with respect to the cut-out 52 to adjust its orientation with respect to main support plate 20. In this way, a user may adjust the angle of touch interface device holder 54 to accommodate the desired position of a touch pad interface device held by the touch pad interface holder 54. In some embodiments, touch pad interface holder 54 may comprise a planar support surface 54S, a catch 54C for engaging the main support plate 20 to prevent the touch pad interface holder 54 from pivoting entirely through the opening 56, and an aperture 54A for enabling a wire to extend through the touch pad interface device holder 54 to connect to a touch pad positioned on the touch pad interface device holder 54.

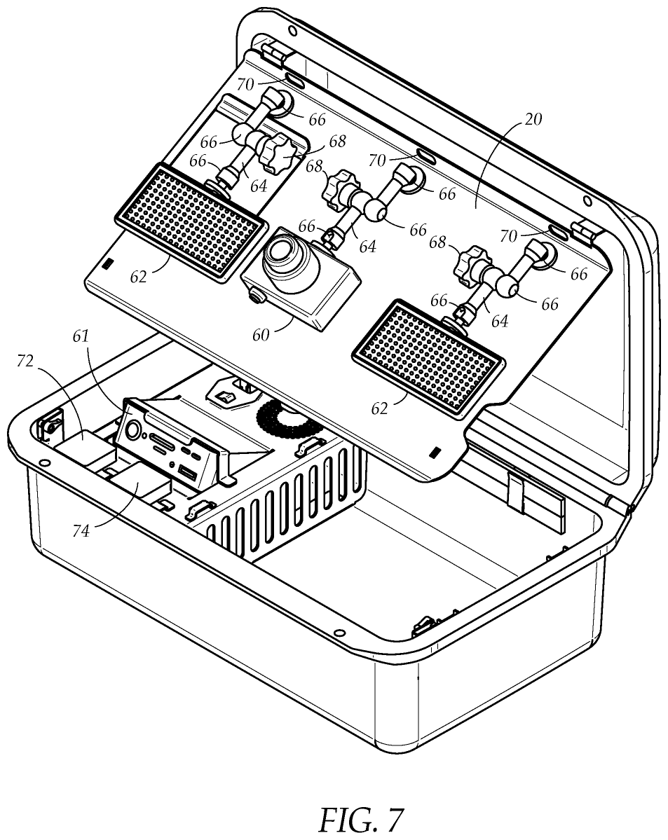

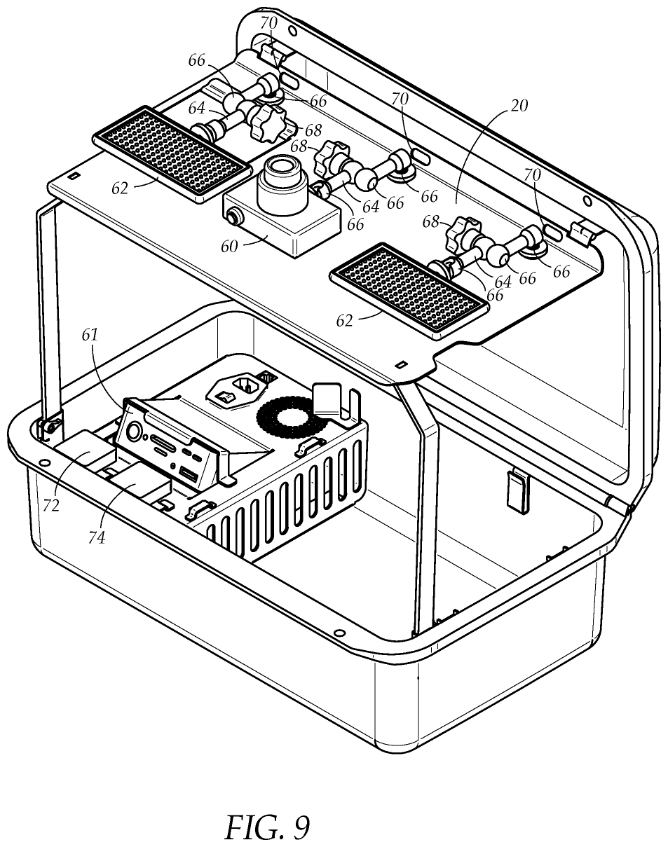

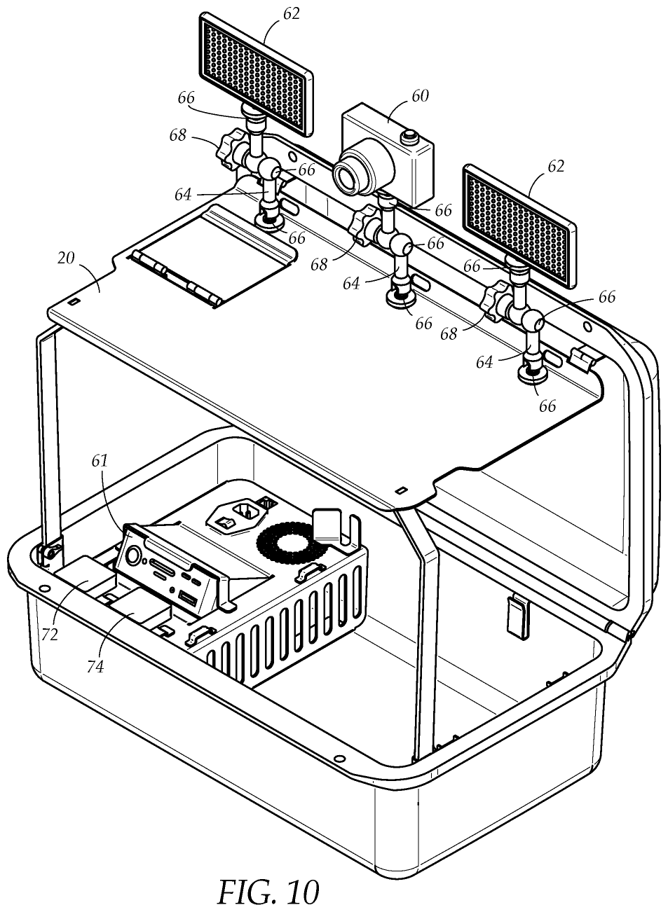

Referring now to FIG. 2, FIG. 7, FIG. 9, and FIG. 10, in embodiments, device 10 may comprise various studio equipment, such as a camera 60, light source(s) 62, a multiport docking station hub adaptor 61, a wireless microphone 72 and transceiver 74 for transmitting audio wirelessly, and the like. In certain embodiments, a pair of light sources 62 and camera 60 may be coupled proximate the rear side 22 of main support plate 20 via pivot arms 64, and the camera 60 may be positioned between the pair of lights sources 62. Pivot arms 64 may include one or more pivot points 66 enabling adjustment of the orientation of the camera 60 and/or light sources 62 with respect to the main support plate 20. Additionally, fasteners 68 may be provided for tightening pivot arms 64 and securing them in position after adjusting their orientation. The rear side 22 of the main support plate 20 may further include one or more apertures 70 corresponding to the camera 60 and the pair of lights sources 62 enabling the passage of cables through the apertures 70 to connect to the camera 60 and the pair of light sources 62 to a power source or other electronic device. In some embodiments, multiport docking station hub adaptor 61 may be configured for receiving various types of cables to make connections with various types of electronic devices requiring varying electrical cables and connections for operation. In certain embodiments, multiport docking station hub adaptor 61 may include, for example, its own power source as well as one or more output connectors 63 for connecting and providing power to primary electronic devices such as a tablet computer or laptop and various female input ports 65 for connecting and interfacing with auxiliary electronic devices. The output connectors may include, for example, USB, HDMI, DisplayPort, DVI, VGA connectors, and other like audiovisual connectors, or any combination thereof. Input ports 65 may include, for example, USB, Thunderbolt, FireWire, DisplayPort, HDMI, 30-pin dock, Ethernet, Mobile High-Definition Link (MHL), RCA, VGA, S/PDIF ports, and other like audiovisual ports or interfaces, or any combinations thereof. The control module receiving center housing 38H may include one or more portals 67, i.e., holes or apertures, for enabling various power cables and connectors, such as the output connectors 63, to extend through the housing 38H to connect to the power supply 38P.

Thus, the disclosed subject matter provides a portable video studio desktop stand device and system which may include video studio quality cameras, lighting, and sound for creating, optimizing, and streaming and/or recording content while traveling or in remote locations. The system provides a versatile platform that may be set up in a sitting desktop position, which may be ideal for working at a desk or table; or in a standing position, which may be best suitable for use while standing (e.g., for delivering a presentation, recording media content, and the like). It shall be appreciated however, that the terms ‘standing’ and ‘sitting’ are not intended to imply that use of the device is limited to the user being in a standing or sitting position in any of these configurations.

The disclosed system may be used by entrepreneurs, influencers, businesspeople, and content creators of any kind, for example, for creation and/or delivery of their content while traveling or in remote locations, and provides a portable system for easy transport and deployment of studio quality equipment.

It shall be understood that while certain aspects of conventional technologies have been discussed to facilitate the present disclosure, no technical aspects are disclaimed and it is contemplated that the claims may encompass one or more of the conventional technical aspects as known in the art.

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

It shall be understood that when an element is referred hereinabove as being “on” another element, it can be directly on the other element or intervening elements may be present therebetween. In contrast, when an element is referred to as being “directly on” another element, there are no intervening elements present. Moreover, any components or materials can be formed from a same, structurally continuous piece or separately fabricated and connected.

It shall further be understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms or orientation or positional relationships indicated by terms such as “upper”, “lower”, “front”, “rear”, “left”, “right”, “top”, “bottom”, “inside”, “outside,” “beneath,” “below,” “above,” and the like, are used herein for ease of description, to describe one element or feature's relationship to another element(s) or feature(s) as illustrated in the figures, rather than indicating or implying that the indicated device or element must have a specific orientation or are constructed and operated in a specific orientation, and therefore should not be construed as a limitation of the present invention. It is further to be understood that these terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly. The term “substantially” is defined as at least 95% of the term being described and/or within a tolerance level known in the art and/or within 5% thereof.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

It shall be appreciated that the disclosed device and system can have multiple configurations in different embodiments, and may be employee for alternate uses and technical fields. It shall be appreciated that the device and system described herein may comprise any alternative known materials in the field and be of any color, size, and/or dimensions. It shall be appreciated that the device may be manufactured and assembled using any known techniques in the field.

The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A portable studio system device, comprising:
a case including an interior compartment, an upper portion, and a lower portion, the upper portion and the lower portion hingedly connected enabling the upper portion and the lower portion to pivot with respect to each other into an open position to provide access to the interior compartment and a closed position to seal the interior compartment;
at least two support members;
at least two support member upright holders in the lower portion, the support member upright holders configured to support the support members in an upright orientation;
a main support plate hingedly connected to an interior side of upper portion, the main support plate being configured to pivot outwardly into a deployed configuration and inwardly into a stowed configuration with respect to the upper portion,
wherein the support members are configured to optionally support the main support plate in the deployed configuration of the main support plate when the support members are engaged within the support member upright holders,
wherein the main support plate forms an elevated planar horizontal support surface in its deployed configuration.

2. The portable studio system device of claim 1, further comprising:
a first set of brackets in the lower portion, the first set of brackets configured to receive and suspend one of the support members laterally across a width of the lower portion; and
a second set of brackets in the lower portion, the second set of brackets configured to receive and suspend the other one of the support members laterally across a width of the lower portion,
wherein the support members are further configured to optionally form a lower planar horizontal support area when the support members are engaged within the first set of brackets and the second set of brackets.

3. The portable studio system device of claim 2, wherein the elevated planar horizontal support surface formed by the main support plate, and the lower planar horizontal support area formed by the support members are configured to receive and maintain objects such as one or more smart electronic devices.

4. The portable studio system device of claim 2, wherein the upper portion includes an interior side ceiling, an upper perimeter edge, and a wall extending between the interior side ceiling and the upper perimeter edge, the wall being substantially orthogonal to the ceiling,
wherein the main support plate is hingedly connected to the wall of the upper portion,
wherein the main support plate is substantially orthogonal relative to the ceiling in its deployed configuration, and substantially parallel to the ceiling in its stowed configuration, and
wherein the wall in conjunction with ceiling of the upper portion defines an upper receptacle configured to receive the main support plate therein when the main support plate is in its stowed configuration.

5. The portable studio system device of claim 4, wherein the lower portion includes a base having a lower perimeter edge, and an upstanding wall extending substantially orthogonally upwards from the lower perimeter edge, wherein the upstanding wall includes a rear wall, a front wall opposite the rear wall, a first side wall, and a second side wall opposite the first side wall, wherein the rear wall, the front wall, the first side wall, and the second side wall define a lower receptacle in conjunction with the base of the lower portion.

6. The portable studio system device of claim 5, further comprising a control module receiving center in the lower receptacle of the lower portion, the control module receiving center being contained within a control module receiving center housing, and configured to removably receive a control interface for powering and interfacing with electronic devices.

7. The portable studio system device of claim 6, wherein the first set of brackets include a first bracket member disposed on the control module receiving center and a second bracket member disposed on the second side wall, the first bracket member and the second bracket member being symmetrically aligned over a central lateral axis of the lower portion,
wherein the second set of brackets include a third bracket member disposed on the control module receiving center and a fourth bracket member disposed on the second side wall, the third bracket member and the fourth bracket member being symmetrically aligned over a central lateral axis of the lower portion, and
wherein the first set of brackets and the second set of brackets are symmetrical over a central longitudinal axis of the lower portion.

8. The portable studio system device of claim 7, the support member upright holders including a first slot disposed on the first side wall and a second slot disposed on the second side wall, the first slot and the second slot being symmetrically aligned over a central lateral axis of the lower receptacle.

9. The portable studio system device of claim 1, further comprising an auxiliary support plate slidably disposed on a lower surface of the main support plate via a rail system.

10. The portable studio system device of claim 1, wherein the main support plate includes a device holder which is pivotable for an adjustable orientation with respect to the main support plate.

11. The portable studio system device of claim 1, further comprising a camera and at least one light source coupled the main support plate via pivot arms.

12. The portable studio system device of claim 1, further comprising a support member stowing bracket in the lower member configured for stowing the support members.
